(19) United States
(12) Patent Application Publication
(10) Pub. No.: US 2005/0041554 A1
(43) Pub. Date: Feb. 24, 2005

(54) Method of recording addresses onto high-density read-only recording medium, a high-density read-only recording medium containing addresses recorded by the method, and reproducing method of the high-density read-only recording medium

(76) Inventors: Jung-Bae Park, Kyunggi-do (KR); Sang Woon Suh, Seoul (KR)

Correspondence Address: HARNESS, DICKEY & PIERCE, P.L.C., P.O. BOX 8910, RESTON, VA, 20195, US

(21) Appl. No.: 10/492,588

(22) PCT Filed: Aug. 16, 2003
(86) PCT No.: PCT/KR03/01656

(30) Foreign Application Priority Data
Aug. 17, 2002 (KR) 10-2002-0048744

(51) Int. Cl. G11B 5/09; G11B 7/24

(52) U.S. Cl. 369/59.25; 369/47.27; 369/275.3

(57) ABSTRACT

The present invention relates to a method of recording addresses onto a high-density read-only recording medium and a high-density read-only recording medium containing addresses recorded thereby. In a high-density read-only recording medium in accordance with the present invention, data is recorded in a plurality of recording blocks wherein each block is composed of a Run-in, a physical cluster in which a part of the data has been written after being ECC-formatted and modulated, and a Run-out, and each block has its address in its Run-in and/or Run-out.

### 1. TECHNICAL FIELD

The present invention relates to a method of recording/reading address information onto/from a high-density read-only recording medium such as a Blu-ray Disk Read-Only (abbreviated as ‘BD-ROM’) and further relates to a high-density read-only recording medium containing address information recorded by said method.

### 2. BACKGROUND ART

Recently, standardization of a novel high-density optical disc, a rewritable Blu-ray disc (BD-RE: Blu-ray Disc-Rewritable), wherein high quality video and audio data can be recorded for many hours is in rapid progress. Once the standard of a BD-RE is establish, products adopting the new optical discs are expected to be developed and released to consumer market in the near future.

As illustrated in FIG. 1, a BD-RE is so structured that from the inner hole of the disc, clamping area, transition area, BCA (Burst Cutting Area) area, and lead-in area are located in a sequential order along radial direction. Data area and lead-out area reside in the center and outermost annulus of the disc, respectively.

FIGS. 2a and 2b show an RUB (Recording Unit Block) defined in the BD-RE standard under discussion. A single RUB, which is corresponding to a single ECC (Error Correction Code) block, is composed of a Run-in, a physical cluster, a Run-out, and a guard area (Guard3), as shown in FIG. 2a.

If a plurality of RUBs, namely, successive RUBs are created at a time to store real-time data, e.g., A/V data, the set of a Run-in, a physical cluster and a Run-out is repeated as many times as necessary and a guard area ‘Gurar3’ is then formed at the end, as shown in FIG. 2b. The guard ‘Guard3’ is created at the end to prevent new data from being overlapped with previously-recorded data.

The Run-in of an RUB, as shown in FIG. 3a, consists of a 1100-channel-bit guard ‘Guard_1’ and a 1660-channel-bit preamble. And, 55 repetitions of a 20-channel-bit pattern are written in the guard ‘Guard_1’ to indicate head of an RUB.

The Run-out of an RUB, as shown in FIG. 3b, is composed of a 540-channel-bit guard ‘Guard_2’ and a 564-channel-bit post-amble. A 20-channel-bit pattern is repeated 27 times in the guard ‘Guard_2’ to indicate end of an RUB.

The guard ‘Guard3’, as shown in FIG. 3c, includes 27 repetitions of a 20-channel-bit pattern to indicate end of successive RUBs.

Therefore, an apparatus such as a disk recorder can identify head or end of each RUB and end of a block of successive RUBs by detecting corresponding guard areas.

When data is recorded on a BD-RE, an address is-written in an RUB, which is corresponding to an ECC block, to enable random access of recorded RUBs. The address is written more than one place in a physical cluster of an RUB after-being ECC-encoded and modulated along with data.

Thus, data in a physical cluster must be demodulated and decoded in order to know an address written therein. However, such demodulation and decoding for an address is burden to a disk system, e.g., a disk recorder or player, and is an obstruction to rapid random access of recorded data.

In the meantime, the standardization of a high-density read-only recording medium, called ‘BD-ROM’, is also under discussion in company with the standardization of a BD-RE.

By the way, it would be preferable to support random access of data written on a BD-ROM. However, if the aforementioned address recording method for a BD-RE was adopted for a BD-ROM, a BD-ROM would have the same problems that address identification needs undesirable burden and is disadvantage to speed of random access as a BD-RE.

### 3. DISCLOSURE OF INVENTION

It is an object of the present invention to provide an address recording method that enables rapid random access of recorded data on a high-density read-only recording medium such as a BD-ROM.

It is another object of the present invention to provide a high-density read-only recording medium on which an address has been recorded through said method and to provide a reproducing method of said read-only recording medium.

A read-only recording medium in accordance with the present invention is characterized in that its data has been recorded in form of a plurality of data blocks, each of the data blocks includes a Run-in area, a physical cluster containing a part of the data, and a Run-out area, and the Run-in and/or the Run-out area comprises an address of the data block.

A method of forming data on a read-only recording medium in accordance with the present invention is characterized in that it comprises the step of: recording the data in each physical cluster of a plurality of data blocks, each of the data blocks comprising a Run-in area, a physical cluster, and a Run-out area, while recording an address of each data block in a Run-in and/or a Run-out area included therein.

A method of reproducing a read-only recording medium on which data has been written in form of a plurality of data blocks is characterized in that it comprises the step of: reading bits from a Run-in and/or a Run-out area of the data block that is composed of a Run-in area, a physical cluster, and a Run-out area; and determining address of segment of the data recorded in the physical cluster of the data block, based on the read bits.

The above-characterized address recording method and a read-only recording medium containing a thusly-recorded address enable immediate use of address recorded in a Run-in or a Run-out without any decoding load to system during reproduction, so that a target location on the recording medium can be accessed more rapidly.

### 4. BRIEF DESCRIPTION OF DRAWINGS

In the drawings:

FIG. 1 shows the structure of a rewritable disk BD-RE (Blu-ray Disk REwritable);

FIGS. 2a and 2b show respective formats of a recording unit block of a BD-RE;

FIGS. 3a to 3c show Run-in, Runout, and guard ‘Guard3’ area, respectively, included in an RUB of a BD-RE;

FIG. 4 shows a BD-ROM whose recording area has been divided into a plurality of logical zones in accordance with the present invention;

FIGS. 5a and 5b illustrate a Run-in area of an RUB of a BD-ROM in accordance with the present invention;

FIGS. 6a and 6b illustrate a Run-out area of an RUB of a BD-ROM in accordance with the present invention; and

FIG. 7 illustrates a block diagram of a disk player capable of reproducing a recording medium.

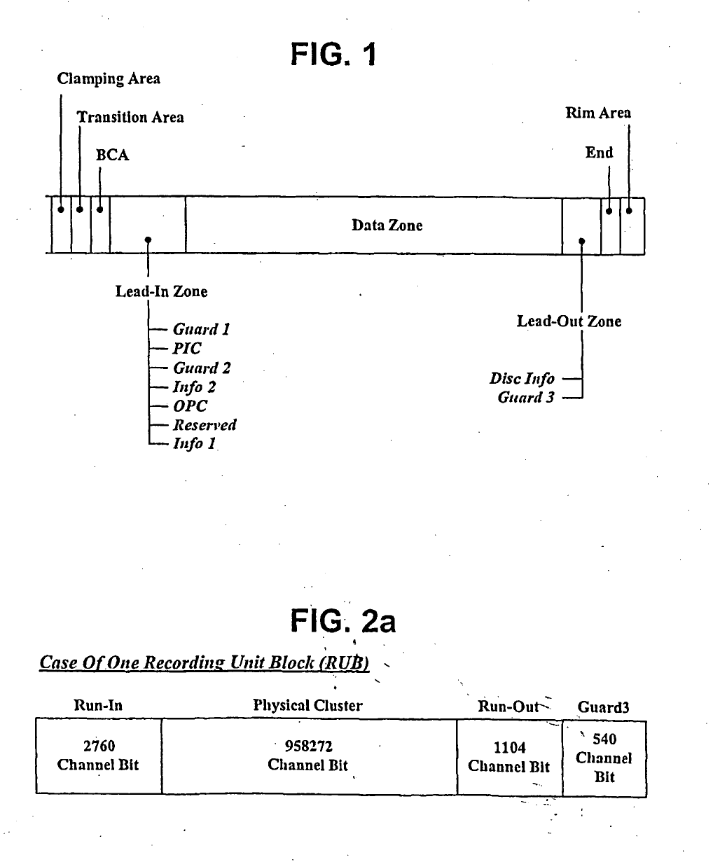

### 5. MODES FOR CARRYING OUT THE INVENTION

In order that the invention may be fully understood, preferred embodiments thereof will now be described with reference to the accompanying drawings.

An address recording method for a high-density read-only optical disk in accordance with the present invention is applied to a BD-ROM manufacturing process, especially, pre-pit forming process.

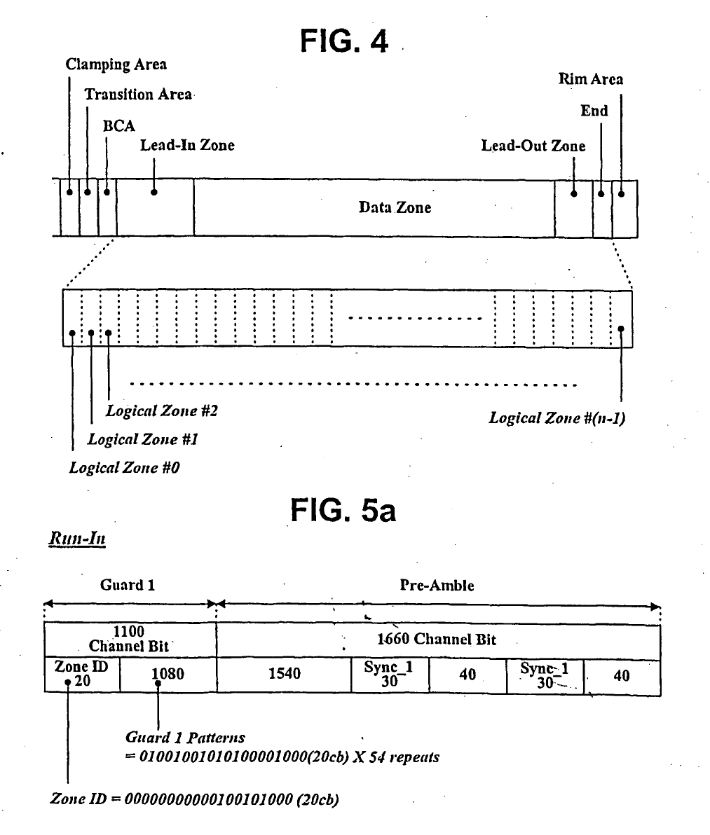

The BD-ROM in accordance with the present invention comprises a clamping area, a transition area, a burst cutting area (BCA), a lead-in area, a data area and a lead-out area, as shown in FIG. 4.

In addition, some or all of the three successive areas of a lead-in, a data area, and a lead-out are logically divided into n zones #0 to #(n−1). The size of a logical zone is fixed in the BD-ROM manufacturing process.

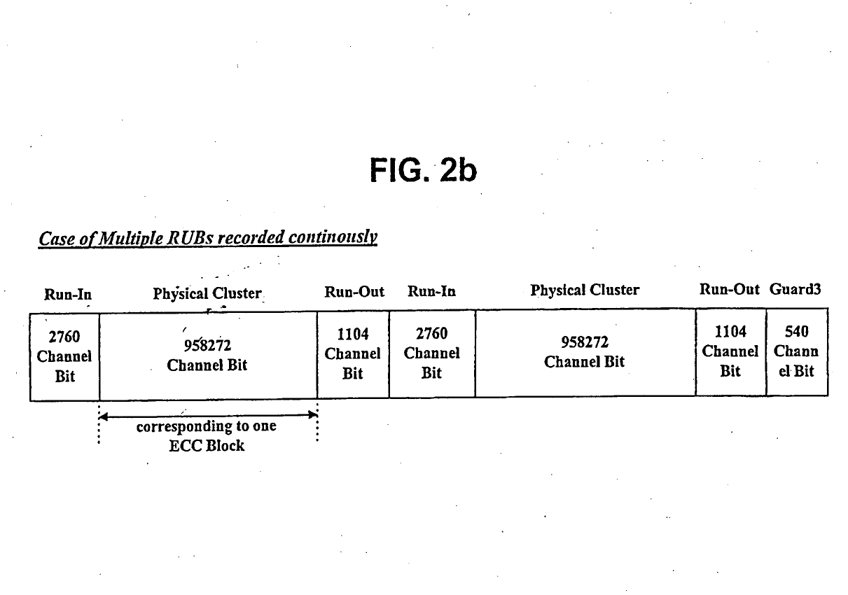

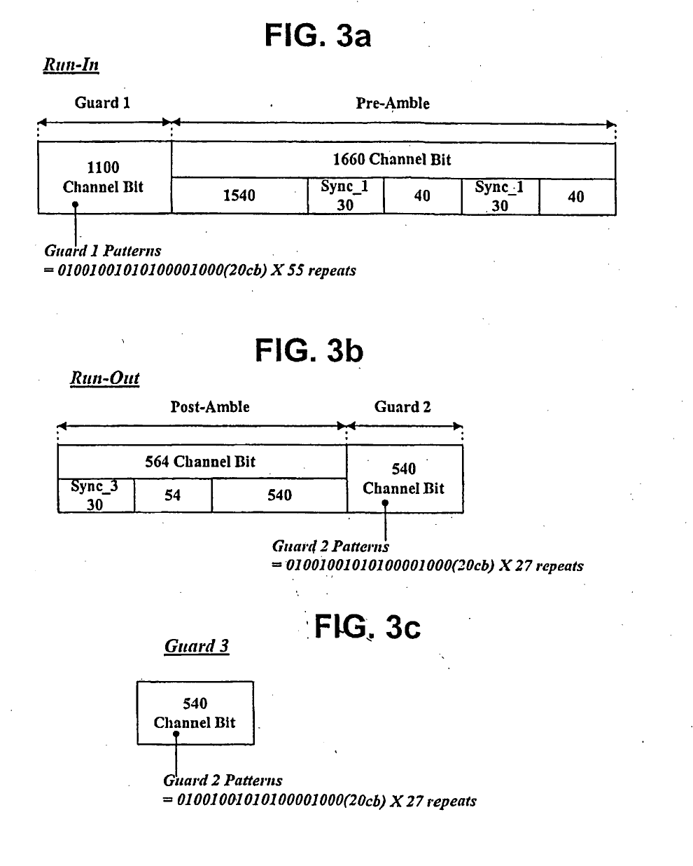

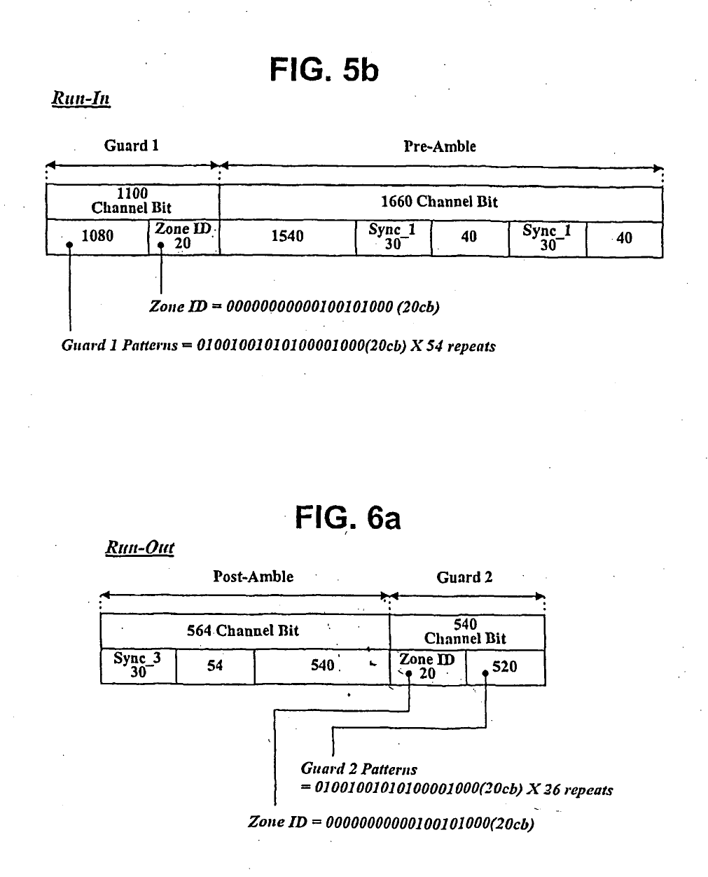

As described above with reference to FIGS. 2a and 2b, data recorded on a BD-ROM is also encapsulated in more than one RUB that is corresponding to a single ECC block. However, the RUB of BD-ROM is different in format from that of a BD-RE. That is, the 2760-channel-bit Run-in included in an RUB of a BD-ROM, as shown in FIG. 5a, has a distinctive guard ‘Guard1’ that is structured differently from the Run-in of a BD-RE.

The guard ‘Guard1’ structured in accordance with the present invention includes a 20-channel-bit zone ID to indicate which logical zone among n zones its RUB pertains to.

Comparing with a BD-RE, the size of bit information to indicate head of an RUB of a BD-ROM is reduced by 20 channel bits in order to reserve a recording field of the zone ID. Therefore, a 20-channel-bit pattern is repeated not 55 but 54 times to indicate head of an RUB. Consequently, the physical size of an RUB does not differ between a BD-RE and a BD-ROM.

If necessary, the size of zone ID may be enlarged. For instance, the size of zone ID may be fixed to 40 channel bits. In this case, repetition times of a 20-channel-bit pattern is reduced by two in comparison with a BD-RE.

The 20-channel-bit zone ID may be placed behind of the 1080-channel-bit bit information to identify head of an RUB as illustrated in FIG. 5b.

A single logical zone can include k RUBs where k>1. In this case, all of the k RUBs have same address. However, if logical zones are set in the manner that a single RUB is mapped to a single logical zone, every RUB has its unique address.

In the event that a single logical zone is mapped to a single RUB that is corresponding to a single ECC block, the zone ID can be used as a unique address of an RUB as well. Therefore, RUBs can be accessed in random with reference to individual zone IDs.

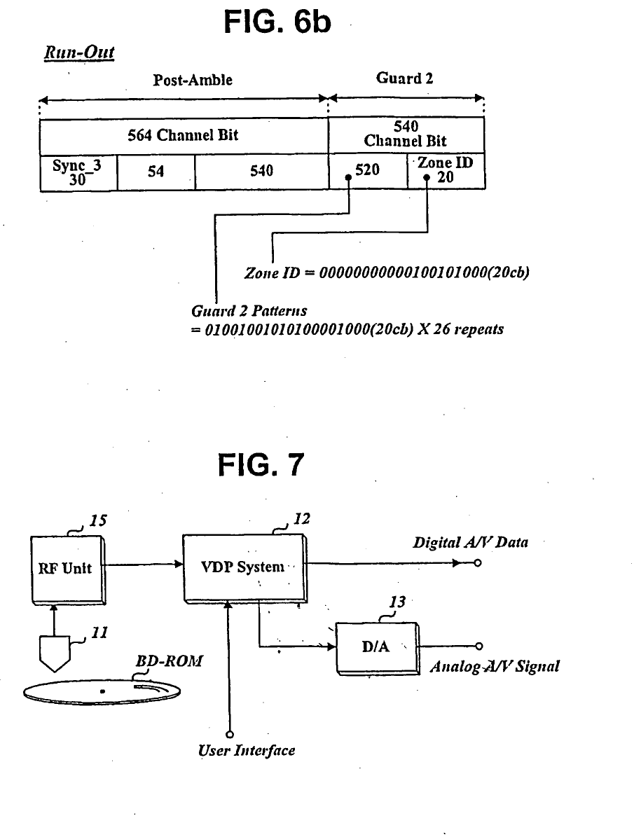

As another embodiment of zone ID recording, the zone ID can be written within a guard ‘Guard_2’ included in the 1104-channel-bit Run-out of an RUB, as illustrated in FIG. 6a. In this embodiment, if the size of zone ID is fixed to 20 channel bits, the bit information to indicate end of an RUB is composed of not 27 but 26 repetitions of a 20-channel-bit pattern, so that the physical size of an RUB is not different from that of a BD-RE.

The 20-channel-bit zone ID may be placed behind of the 520-channel-bit bit information to identify end of an RUB as illustrated in FIG. 6b.

FIG. 7 shows a simplified block diagram of a disk player that consists of an optical pickup 11 reading a recorded signal; an RF unit 15 binarizing a read signal from the pickup 11; a VDP (Video Disk Player) system 12 converting the binarized signal to bit stream and, if necessary, restoring the bit stream to original data through demodulation and error correction; and a D/A converter 13 converting the restored data to an analog signal.

When a BD-ROM containing the zone IDs in its Run-in and/or Run-out is placed in, the disk player of FIG. 7 is able to know immediately the position of the pickup 11 on the BD-ROM without any demodulation. More detailed explanation is as follows.

The VDP system 12 converts a recorded signal, which is read from a Run-in and/or a Run-out of a current RUB and binarized by the RF unit 15, to corresponding bit stream and searches the bit stream for 20 channel bits just before or behind 54 repetitions of same pattern (in case that a zone ID is written in each Run-in area) or just before or behind 26 repetitions of same pattern (in case that a zone ID is written in each Run-out area). The zone ID (location identifying value) can be directly known from the found 20 channel bits without demodulation and error correcting process. Since location is determined very fast from the zone ID, a target position can be searched and accessed that fast.

In the above embodiments, a part of the zone ID written in the first guard ‘Guard_1’ of the Run-in area and/or in the second guard ‘Guard_2’ of the Run-out area can be used to indicate which region among a lead-in, a data area and a lead-out area a current RUB pertains to.

For instance, 2 head bits of the 20-channel-bit zone ID are allocated to a region code that has ‘00’ for a lead-in, ‘10’ for a data area, and ‘10’ for a lead-out.

In the event that the region code is allocated within the zone ID as above, the disk player is able to immediately know that a long-jumped position is within a lead-in, a data area or a lead-out after simply checking the 2 head bits of a zone ID, so that it can determine quickly and roughly whether the just-conducted long jump is right.

For example, in the event that a long jump is requested inward within a data area, if a zone ID read from a long-jumped location has 2 head bits of ‘00’ the disk player can conduct a short jump outward at once because ‘00’ is indicative of a lead-in.

While the invention has been disclosed with respect to a limited number of embodiments, those skilled in the art, having the benefit of this disclosure, will appreciate numerous modifications and variations therefrom. It is intended that all such modifications and variations fall within the spirit and scope of the invention.

1. A read-only recording medium in which data has been recorded in form of a plurality of data blocks,
wherein each of the data blocks includes a Run-in area, a physical cluster containing a part of the data, and a Run-out area, and wherein the Run-in area comprises an address of the data block.

2. The read-only recording medium of claim 1, wherein the address is written before or behind of repetition of a 20-channel-bit pattern to indicate head of the data block.

3. The read-only recording medium of claim 1, wherein the address is 20 channel bits in size.

4. The read-only recording medium of claim 1, wherein the address further comprises a region identification to indicate which region the data block pertains to among a lead-in area, a data area and a lead-out area of the recording medium.

5. The read-only recording medium of claim 4, wherein the region identification is 2 channel bits in size.

6. The read-only recording medium of claim 1, wherein at least two data blocks have same address.

7. The read-only recording medium of claim 1, wherein each of the data blocks has a unique address.

8. A read-only recording medium in which data has been recorded in form of a plurality of data blocks,
wherein each of the data blocks includes a Run-in, area, a physical cluster containing a part of the data, and a Run-out area, and wherein the Run-out area comprises an address of the data block.

9. The read-only recording medium of claim 8, wherein the address is written before or behind of repetition of a 20-channel-bit pattern to indicate end of the data block.

10. The read-only recording medium of claim 8, wherein the address is 20 channel bits in size.

11. The read-only recording medium of claim 8, wherein the address further comprises a region identification to indicate which region the data block pertains to among a lead-in area, a data area and a lead-out area of the recording medium.

12. The read-only recording medium of claim 11, wherein the region identification is 2 channel bits in size.

13. The read-only recording medium of claim 8, wherein at least two data blocks have same address.

14. The read-only recording medium of claim 8, wherein each of the data blocks has a unique address.

15. A method of forming data on a read-only recording medium, comprising the step of:
recording the data in each physical cluster of a plurality of data blocks, each of the data blocks comprising a Run-in area, a physical cluster, and a Run-out area, while recording an address of each data block in a Run-in and/or a Run-out area included therein.

16. The method of claim 15, wherein the address is recorded before or behind of repetition of a 20-channel-bit pattern that is formed in the Run-in or the Run-out area.

17. The method of claim 15, wherein the address is recorded in such a manner that at least two data blocks have same address.

18. The method of claim 15, wherein the address, is recorded in such a manner that each of the data blocks has a unique address.

19. A method of reproducing a read-only recording medium on which data has been written in form of a plurality of data blocks, each being composed of a Run-in area, a physical cluster, and a Run-out area, comprising the step of:
reading bits from the Run-in and/or the Run-out area of a data block; and
determining address of segment of the data recorded in the physical cluster of the data block, based on the read bits.
